(19) United States
(12) Patent Application Publication
(10) Pub. No.: US 2008/0077417 A1
(43) Pub. Date: Mar. 27, 2008

(54) Systems and Methods for Citation Management

(76) Inventors: William A. Lazzarino, Kinnelon, NJ (US); Cameron Bentley, Ilkley (GB); Judith Isabelle Brinkmann, Waterloo, IL (US); Brian E. Carr, Chesterfield, MO (US); Gary Wayne Cunningham, Huntington Beach, CA (US); Terrance J. Donohue, Des Peres, MO (US); Kiran Hatti, Chesterfield, MO (US); Natasha Gaye Hrycauk, Toronto (CA); Thomas A. Klinger, Aurora, CO (US); Karl Markiewicz, Berlin (DE); Merri Jean Manetzke, Eureka, MO (US); Wade Arlen McKee, St. Peters, MO (US); Patricia A. Nesvold, St. Charles, MO (US); Bruce Peck, Fair Oaks, CA (US); Dale Rickard, Chesterfield, MO (US); Mandeep Sandhu, O'Fallon, MO (US); Jon Strawn, Wheaton, IL (US); Bradley K. Wolniak, Boca Raton, FL (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/534,114

(22) Filed: Sep. 21, 2006

(51) Int. Cl. G06Q 10/00

(52) U.S. Cl. 705/1

(57) ABSTRACT

Systems and methods, such as may be executed by a computer or computer network, for the management of citations issued to an owner of a fleet of vehicles which identify the vehicle and the time of the citation. The systems and methods allowing for automatic matching of the citation to the party responsible for the vehicle at the time of the citation by matching the citation to a contract indicating the party responsible for the vehicle at the time of the citation.

### BACKGROUND

1. Field of the Invention

This disclosure relates to the field of citation management, particularly to computer systems and methods which can be used to process traffic citations for a fleet owner such as a rental vehicle agency.

2. Description of the Related Art

While everyone understands the need for traffic enforcement systems and rules requiring drivers to operate their vehicles within accepted norms, nobody likes to receive traffic tickets. Receiving a citation for a traffic violation is generally not a pleasant experience. At the same time, traffic citations are relatively common, fairly routine, and relatively painless when it comes to possible punishment for illegal activity. Most traffic citations do not require any type of trial or other type of legal proceeding, but instead simply involve the party receiving a citation and then making an appropriate payment. It is, in fact, the case that in some jurisdictions traffic citations (and also parking citations and toll violations) are seen less as a way to enforce necessary laws than a method for the jurisdiction to gain additional revenue to fund the basic services for a community.

Trying to enforce traffic laws against a populace which generally treats speed limits as speed recommendations and which will generally also ignore traffic signals so long as they think it is safe to do so can be a challenge. It also has led to a number of innovations in the manner in which traffic citations are issued. Originally, in order for there to be a traffic citation, a law enforcement officer would have had to be present when the offense occurred. The officer would then pull over the vehicle and obtain identifying information from the driver. The officer would then generally confirm the driver's identity and issue the citation based on their identification and the identification of their vehicle. A paper copy of the citation would be provided to the driver, so that they had a record of the citation either to admit guilt and to pay the fine or to serve as their basis for challenge, and a second copy would be retained by the law enforcement officer to be provided to the issuing agency as a record of the issuance of the citation. This record was used to make sure that the fine was either paid or challenged in a timely fashion and as the basis to initiate collection actions, as necessary.

This process has certain advantages in that the citation is provided directly to the individual who is accused of a violation of law. As the law enforcement officer actually checked identification and gave the ticket to the driver at the time the citation was issued, barring the presentation of counterfeit identification documents, the identified party had actually committed the violation with the vehicle that he was operating when he received the ticket.

This process, however, is time intensive and there are only a limited number of law enforcement officers who can spend their time issuing traffic citations. Even if there are significant numbers of officers available, it is still the case that the number of individuals violating the law is often so great that many get away with their actions simply because an officer was already busy with another individual when the later violation was committed. Further, while this type of system provides for punishment of offenders it often does not discourage offending behavior as the chance of actually being caught for any one violation is generally relatively small and, as discussed above, the punishment is relatively minor. Therefore, violation of traffic laws becomes commonplace.

Recently, methodologies for giving citations which are more automated have become increasingly common. In particular, new ticketing systems utilize automated systems which can identify the offending vehicle and sometimes also the driver in a fashion that then allows a citation to be automatically generated and sent to the suspected offending party. Red light cameras, speed cameras and other such technology are becoming increasingly commonplace to provide for improved detection of illegal activity. In particular, these types of systems provide for an ever vigilant ticketing “officer” which can issue a ticket for every vehicle in the monitored area that carries out the illegal activity.

These technologies often operate on a similar principle to the way that parking or toll violations are assessed which is based on assessing the violation against the vehicle and its owner instead of necessarily against the operator of the vehicle. In parking violations in particular, the operator who illegally parked the vehicle is generally not present at the time that the citation is issued. Therefore, the vehicle registration (particularly the listed owner of the vehicle) is used as a default for the operator who has actually committed the violation. In most cases the owner (or someone they have authorized to use the vehicle such as a family member) will be the one who has committed the violation, and therefore holding them responsible makes logical sense. In the small cases where this is not true, it is left to the parties to sort out responsibility with the issuing authority not needing to be involved.

Toll violations, and various traffic enforcement cameras, often use similar default identifications on moving vehicles. In particular, the cameras often record a picture of the vehicle and the vehicle's license plate number in the act of the violation so that the particular vehicle involved in the violation can be uniquely identified. As license plate numbers, when not counterfeited or similarly misused, uniquely identify the vehicle and are associated with its owner, the ticket can be provided to the owner of the vehicle along with the video evidence showing the vehicle involved in the illegal act. The owner of the vehicle is then presumed to be operating it at the time of violation or is at least responsible for the violation until they prove otherwise. Other systems try to be even more accurate in identification by taking a picture of the operator of the vehicle or otherwise attempting to identify the vehicle, operator, or both. This picture or other material can then serve as evidence as to whether the owner was or was not actually operating the vehicle.

With regards to proof, the default position of owner as operator generally provides a reasonable initial position. The owner of the vehicle is liable for the violation unless they can prove (or attest) that they were not operating the vehicle at the time the violation occurred. In this situation, they can attempt to transfer the liability to the actual operator using various statements to that effect; however, they may still be liable for the resulting fine if the actual operator does not pay but they may be able to pursue the operator separately, or the citation may be determined to simply be uncollectible and thrown out.

While this default position of owner as operator in an automatic citation-issuing system is generally a good default, in some cases it proves to be highly problematic. In particular, the system is relatively time-intensive for the owner to review the information, determine if they were operating the vehicle, and to either pay or contest the citation. The time intensity is generally not a problem for most vehicle owners who may own just 2 or 3 vehicles and only receive a citation every so often. However, this time intensity becomes highly problematic for a corporation which owns, leases, or is otherwise responsible for a fleet of vehicles which are used by a large number of individuals.

The situation is particularly difficult if there is no type of employment or other relatively long term relationship between the vehicle operators and the vehicle owner. In a vehicle rental situation, for example, the owner, a corporation which is generally providing the vehicle to be used by another is the “operator” of the vehicle in very few cases. Further, given that citation-issuing authorities often have a fairly long delay before citations are provided to the owner, the renter may have long parted ways with the owner at the time the owner is made aware of the citation.

In a commercial fleet of vehicles used by employees, contractors, or others in the specific course of performing the business they have been hired to perform, the inability to link up vehicles to operators may not be a significant concern as the corporation may simply treat the payment of citation fees as overhead or may be able to link up the citations with particular employees by simply implementing vehicle operation policies if they need or want to. For rental fleets, however, citations can cause a tremendous problem. In these cases, the owner may have as many as several hundred people who have used any particular vehicle in its lifetime and those people are generally not employees who are more easily identified and located, but customers who are transient.

Because of the way many automated citations are generated and sent, citations are often sent out a significant amount of time after the violation occurred. Further, many people renting a vehicle from an owner believe they are relatively anonymous. After all, they may have rented the vehicle using an address that is no longer accurate and paid cash to rent so that the chance of the owner locating them is minimized and making them pay a fine associated with their violation is difficult. Because of this perceived anonymity of operating a rental vehicle and because many people feel that an owner will be unwilling to expend the resources to pursue them for a violation, they may be more likely to run a toll booth or park illegally expecting that the owner is unable to determine that the violation was their fault, and even if they can, be relatively judgment proof as they are not worth pursuing for what is a relatively small amount of money.

Together, these issues can create a situation where an owner has a potentially large amount of costs incurred as a result of citations which may be too expensive to collect if they can collect them at all. Further, due to the sheer size of many rental fleets, rental agencies can be called on to handle thousands of citations from a large number of different jurisdictions and issuing authorities every year, all of which have different rules and requirements. For these reasons, an owner is often unable to resolve citations simply because it is cost prohibitive to try and manage the citations compared to simply paying them. Instead, rental agencies often internalize the aggregate costs of citations and raise their prices impacting all renters. Alternatively, the rental agencies may actually go through the cost of pursuing those who are liable for the citation, but then have to pass on the costs of that pursuit, which are often even more, to their customers. Both of these results are inefficient and result in a system where those who obey the laws and do not receive citations are paying at least some of the cost of those that do.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art there is described herein, among other things, systems and methods for citation management. These systems and methods are generally computer implemented methodologies, or software for implementing such methodologies on a computer or computer network that serve to make it easier to handle the large number of citations a fleet owning agency, such as, but not limited to, a rental vehicle company, receives, link the citations up with the operator (or renter) of the vehicle at the time of the citation, and pursue the renter for costs of the citation, and possibly additional costs associated with having to carry out the enforcement procedures.

This type of system, therefore, serves to provide both a methodology to recoup the costs of citations imposed on a fleet owner by improving their ability to collect on citations and to reduce their costs of handling citations by streamlining the process. The system may also act as a deterrent to citable behavior when operating a fleet vehicle by increasing the ability to collect against a party operating the vehicle in violation and receiving the citation.

The system generally can take in citations from citation-issuing authorities, automatically match at least a large majority of the citations with the renter or other party responsible for the fleet vehicle at the time that the citation was issued, automatically generate necessary output demanded by the issuing authority to transfer liability to the renter of the vehicle from the fleet owner, or to arrange for the fleet owner to pay the citation agency and pursue the renter for their costs.

There is described herein, among other things, a method of managing citations for a fleet of vehicles, the method comprising: having a fleet owner responsible for a fleet of vehicles and a citation-issuing authority; providing a computer; the owner receiving, from the issuing authority, a plurality of citations, each of the citations referencing a vehicle in the fleet and a time of the citation; placing the citations in computer readable form; the computer accessing a database of contracts in computer readable form, the database including a plurality of contracts, each of the contracts in the plurality indicating a period of time during which a renter was responsible for the vehicle; and if the time of a first citation is wholly within the time period of a first contract: the computer automatically matching the first citation with the first contract; the computer automatically generating a document, the document being sufficient to transfer responsibility for the first citation to the renter; and providing the document to the issuing authority.

In embodiments of the method the step of placing is performed by the issuing authority or the owner.

In an embodiment of the method the method further includes the step of indicating that responsibility should be transferred prior to the step of the computer automatically generating the document.

In an embodiment of the method, if the time is not wholly within the time period of any contract within the plurality of contracts the computer indicates that a match was not found and a human being attempts to match the first citation. In this situation, if there is no contract in the plurality of contracts which has a time period which overlaps with the time, responsibility for the citation may be maintained with the owner and if there are multiple contracts in the plurality of contracts which have a time period which overlaps with the time, responsibility for the citation may be maintained with the owner.

In an embodiment of the method, if there is no contract in the plurality of contracts which has a time period which overlaps with the time or if there are multiple contracts in the plurality of contracts which have a time period which overlaps with the time, responsibility for the citation is maintained with the owner.

In embodiments of the method, the step of placing comprises at least one of the following: scanning of paper documents, manual entry of information from documents, or use of a direct electronic input.

In an embodiment of the method if the time of the first citation is wholly within the time period of the first contract: the computer also automatically generates a second document, the second document indicating that the renter is responsible for paying the fine. The computer may then automatically charge the renter for the fine at a time after the second document is provided to the renter.

In an embodiment of the method, the fleet of vehicles are rental cars and the owner is a rental car agency.

In an embodiment of the method matching is verified by a human prior to the computer automatically generating the document to transfer responsibility for the first citation to the renter.

There is also described herein a method of managing citations for a fleet of vehicles, the method comprising: having a fleet owner responsible for a fleet of vehicles and a citation-issuing authority; providing a computer; the owner receiving, from the issuing authority, a plurality of citations, each of the citations referencing a vehicle in the fleet, a time and assessing a fine; placing the citations in computer readable form; accessing a database of contracts in computer readable form, the database including a plurality of contracts, each of the contracts indicating a time period during which a renter was responsible for the vehicle; and if the time of a first citation is wholly within the time period of a first contract: the computer automatically matching the first citation with the first contract; the computer automatically generating a document, the document indicating that the renter is responsible for paying the fine; and providing the document to the renter.

In an embodiment of this second method, the document may indicate that a renter's credit card will be charged if the renter does not pay the fine prior to a specified time, the computer may charge the renter's credit card if the renter does not pay the fine prior to the specified time, and the computer may automatically indicate on the document that the renter is being billed an additional fee. The renter's account information may also or alternatively be sent to another computer system, such as, but not limited to, an accounting system. In another embodiment of the method, the renter pays the fine and fees directly, either to the fleet owner, that then pays the issuing authority, or the issuing authority. The user may provide proof of such payment to the fleet owner to eliminate their responsibility.

In embodiments of the method, the step of placing is performed by the issuing authority or the owner.

In an embodiment of the method, the method further includes the step of, indicating that responsibility should be transferred prior to the step of the computer automatically generating the document.

In an embodiment of the method, if the time is not wholly within the time period of any contract within the plurality of contracts the computer indicates that a match was not found and a human being attempts to match the first citation. In this situation, if there is no contract in the plurality of contracts which has a time period which overlaps with the time, responsibility for the citation is maintained with the owner and if there are multiple contracts in the plurality of contracts which have a time period which overlaps with the time, responsibility for the citation is maintained with the owner.

In an embodiment of the method, if there is no contract in the plurality of contracts which has a time period which overlaps with the time or if there are multiple contract in the plurality of contracts which have a time period which overlaps with the time, responsibility for the citation is maintained with the owner.

In embodiments of the method, the step of placing comprises at least one of the following: scanning of paper documents, manual entry of information from documents, or use of a direct electronic input.

In an embodiment of the method, if the time of the first citation is wholly within the time period of the first contract: the computer also automatically generates a second document, the second document indicating that the renter is responsible for paying the fine. The computer may then automatically charge the renter for the fine at a time after the second document is provided to the renter.

In an embodiment of the method, the fleet of vehicles are rental cars and the owner is a rental car agency.

In an embodiment of the method, the matching is verified by a human prior to the computer automatically generating the document indicating that the renter is responsible for paying the fine.

There is further described herein a computer-readable memory storing computer-executable instructions for citation matching, the memory comprising: computer-executable instructions for inputting a first citation referencing a vehicle in the fleet and a time of the first citation, the first citation also assessing a fine; computer-executable instructions for accessing a database of contracts, the database including a first contract indicating a time period during which a renter was responsible for the vehicle; computer-executable instructions for determining if the time of the first citation is wholly within the time period of the first contract and if so: automatically matching the first citation with the first contract; and automatically generating a document, the document indicating at least one of the following situations: that the renter is responsible for the fine or that the liability for the fine is being transferred to the renter.

In an embodiment of the memory the database of contracts is also stored on the memory and the memory may be distributed across a plurality of computers.

### BRIEF DESCRIPTION OF THE FIGURES

FIG. 1 provides a general block diagram of the layout of a computer system comprising an embodiment of a citation management system or CMS.

FIG. 2 provides a process diagram of steps of operation of an embodiment of a CMS.

FIG. 3A provides a screen shot of an embodiment of a screen which is used for inputting batched citations into a CMS.

FIG. 3B provides a screen shot of an embodiment of a screen which is used to review citations in an individual batch.

FIG. 4 provides a screen shot of an embodiment of a screen which is used to determine if manual assistance is required to match citations to contracts in a batch.

FIG. 5 provides a screen shot of an embodiment of a screen which is used to review the matched and unmatched citations in a batch.

FIG. 6 provides a screen shot of an embodiment of a screen which is used to review specifics of a citation, related vehicle, and issuing agency.

FIG. 7 provides a screen shot of an embodiment of a screen which is used to review specifics of a contract matched to a citation.

FIG. 8 provides a screen shot of an embodiment of a screen which is used to review issuing agency communication information.

FIG. 9 provides a screen shot of an embodiment of a screen used to review comments associated with the machine and user actions within the system.

### DESCRIPTION OF PREFERRED EMBODIMENT(S)

Generally described herein are systems and methods that relate to a computer system, such as can be implemented on an individual computing device or a computer network utilizing a memory having computer-executable instructions for providing the services and methods as discussed herein. The software and methodology generally allow the person or other entity responsible for a fleet of vehicles to manage and organize citations received against that fleet of vehicles. The specific hardware and software layout of the system as discussed herein is intended to be purely exemplary and it would be understood to one of ordinary skill in the art how to adapt the systems and methods to use other hardware and software configurations. This system is generally referred to herein as a citation management system or CMS.

For the purposes of this disclosure, the entity who is principally responsible for a fleet of vehicles will generally be referred to as the “fleet owner”. This entity may comprise an individual, corporation, partnership or any other type of legally recognized entity who controls the fleet. The term “owner” is not intended to require that the entity actually own the vehicles that are part of the fleet. Depending on embodiment, the vehicles may be owned, leased, borrowed, or of any other type of transfer of control to the owner. However the term “owner” is used here to distinguish the entity that is responsible for the fleet as opposed to the entity that is currently responsible for some subdivision of vehicles from the fleet at the time of the citation who is termed the “renter.” Further, it should be recognized that a fleet of vehicles as discussed in the embodiments herein will comprise a fleet of passenger cars and light trucks, but that is not intended to limit the types of vehicles which may be in a fleet that the CMS operates on. Any type of vehicle fleet, whether motorized or not, may be managed by the CMS including, but not limited to fleets including: passenger cars, light trucks, heavy trucks, vans, boats, ships, jet skis, motorcycles, bicycles, aircraft, helicopters, balloons, hovercraft, spacecraft, trailers, cargo containers, boxes, snowmobiles, ATVs, go-carts, mopeds, or any combination of these.

Further, the exemplary CMS described herein will generally be discussed in conjunction with its use by a rental vehicle company having a large fleet of vehicles being the owner with the fleet distributed between various offices, branches, franchises, groups, agencies, or other depots. These depots may provide access to the fleet as individual entities, or may act in an agency or other relationship with the fleet owner. Because of this relationship, the term “owner” in this disclosure refers not only to the overall entity, but to each sub-entity, and any combination thereof which are responsible for at least a portion of the fleet, but which provide access to at least a portion of the overall fleet to other entities for their use. In an alternative embodiment, the CMS may be used by a third party provider who provides access to the CMS to the fleet owner, for instance as an Application Service Provider (ASP) via the Internet. In a still further embodiment, the third party actual serves as a service company providing the CMS system for use by its own agents and providing the use of the CMS system as a service to the fleet owner, who has no direct interaction with it.

The rental vehicle relationship is not the only type of fleet relationship that a CMS may be used to manage citations for, but is generally the most complex and also the most illustrative of operation. Therefore, it is used for exemplary purposes throughout this disclosure of how a CMS operates. Further, a rental vehicle company is used in the exemplary embodiment because a rental vehicle company will generally have a purely contractual relationship with the renters of its fleet which may be highly transitory in nature. That is, the entity(s) who were operating the specific vehicle at any given time is very variable and is subject to few controls after the time period during which the vehicle was rented has ended.

Further, the entity who is operating or responsible for the vehicle at the time of citation due to their relationship with the owner is described herein as the “renter” of the vehicle at the time of the citation (assuming the vehicle is rented at the time of the citation). The term “renter” can refer to an employee of the fleet owner or other temporary operator of the vehicle depending on the particular embodiment and they need not be paying “rent” to operate the vehicle. In effect, the owner controls the fleet while the renter controls at least a portion of the fleet due to their relationship with the owner. Further, the owner could have a number of renters control a vehicle while it is under the global control of the owner.

It is recognized that in some cases the renter may not be the operator of the vehicle at the time of the citation, but those are generally extraordinary cases due to limitations in vehicle rental or similar contracts. In particular, generally a contract restricts operation of the vehicle to the renter or a secondary operator also identified when the contract is signed and for whom the renter takes responsibility. Therefore, the renter is generally contractually bound to be responsible for the operation of the vehicle and even if he was not actually operating it, will generally be contractually bound and responsible for whoever was.

In an extreme case, the vehicle may have been stolen or otherwise illicitly used without the renter's consent or awareness. In this case, the renter will generally be able to provide evidence that they were not the vehicle's operator and should not be responsible for its operation. This type of situation, however, will generally be very rare and can be handled on a case by case basis. As one benefit of the CMS can be improved automation in a majority of citation situations, the general presumption of this disclosure is that the renter is the operator of the vehicle, or is otherwise financially responsible for the actions of the operator of the vehicle when the vehicle has been rented is reasonable as that is the majority expectation.

A vehicle is considered to be rented (or the responsibility of the renter), as that term is used herein, if it is the subject of a “rental contract”. A rental contract is any agreement between the owner and the renter which allows the renter to operate the vehicle in exchange for payment, various guarantees, or other agreed terms (for instance as part of an employment relationship). The contract is transitory in that it is in effect while the vehicle is placed in the renter's possession. It may, however, provide for effects after that time period. Nonetheless, for purposes of this disclosure, the contract will be presumed to relate to the time period during which the vehicle is expected to be operated by the renter, and for which possession the renter is responsible. The contract period thus begins when the vehicle leaves the owner's control. The contract period ends when the vehicle is officially returned and the owner releases the renter from their current obligation as the expected operator of the vehicle.

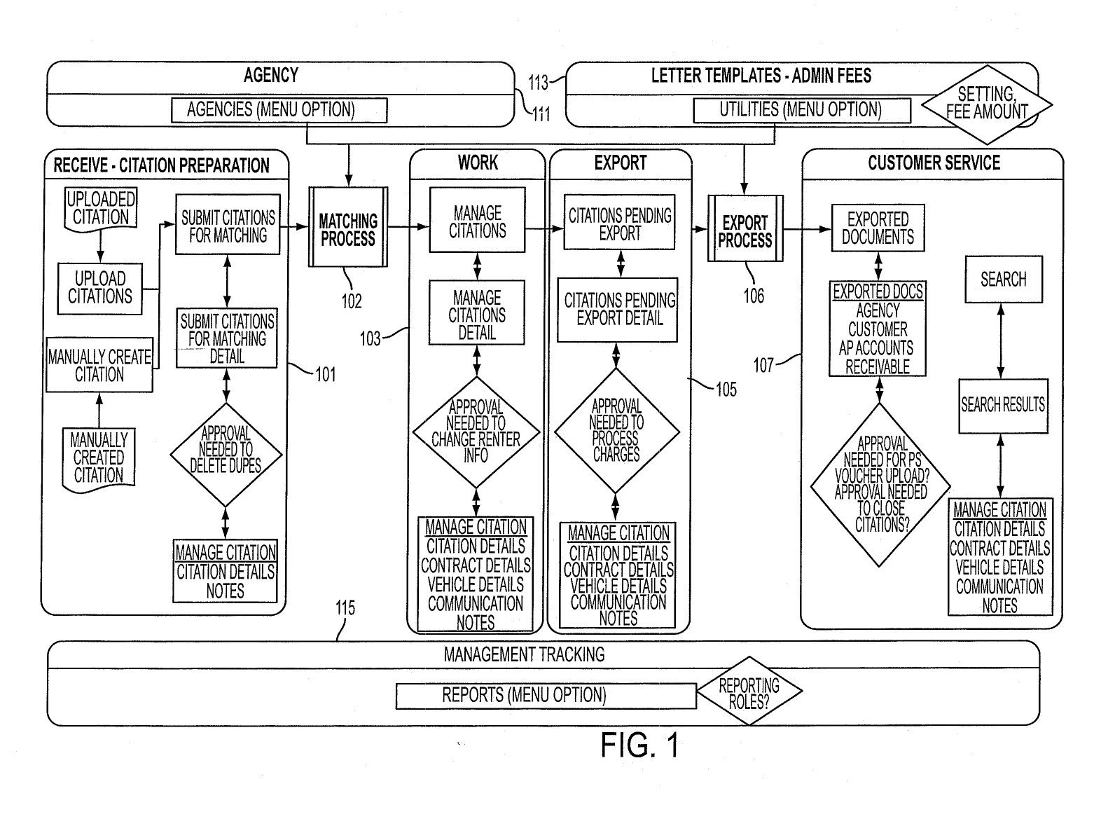

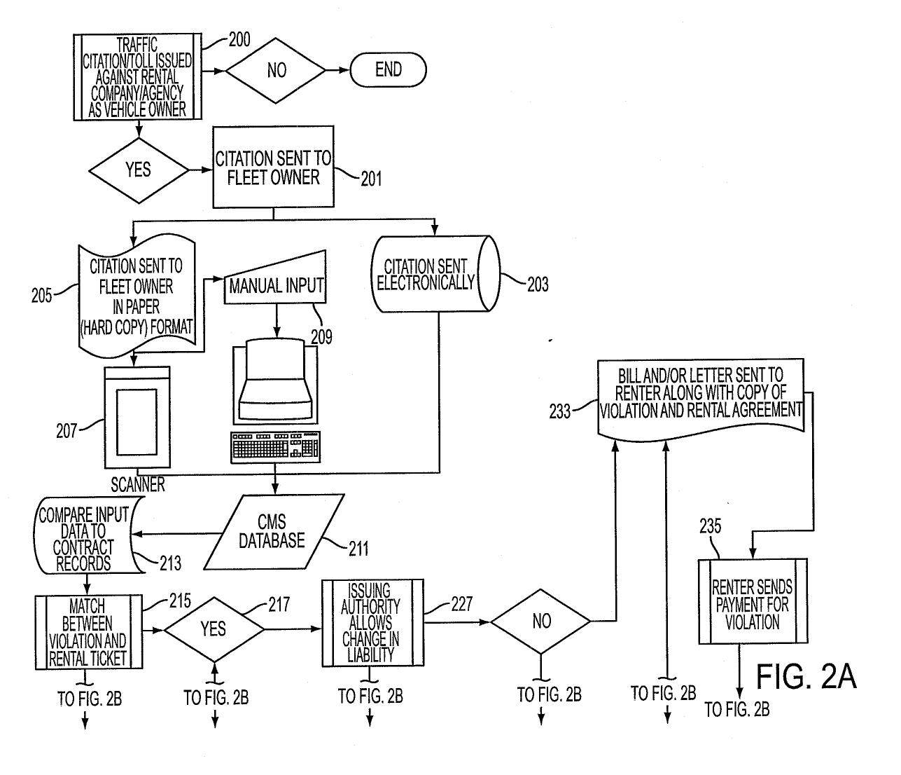

FIG. 1 provides for a general block diagram showing an embodiment of a system which can be used in an embodiment of a Citation Management System (CMS). This diagram is a functional block diagram and shows the various functional components of the CMS. It should be recognized that as a functional diagram, there is no requirement of any particular machine to perform each block, however, in an embodiment, the functional blocks can correspond to machines, or to functional software within a machine, performing the function of the block.

The receiving block (101) generally comprises the receiving process whereby information on citations is taken into the CMS from an issuing authority. The issuing authority may be any authority authorized to issue citations and will generally be a governmental unit, but may also be a private entity operating according to its own authority (such as by part of a license granted to enter or use its premises). The output of the receiving block (101) is linked to a work block (103) by a matching process (102) whereby management and association of citations to contracts is made. In particular, the matching process (102) serves to link up citations with the renter who was responsible for the vehicle at the time of the citation, and provides for intervention in cases where additional information may be needed.

The work block (103) allows for citations which have been through the matching process to be reviewed, revised, or otherwise operated on. The output of the work block (103) is then used by an export block (105) to provide for exported data on the citations to the issuing authority or to a payment or collection system. The export block (105) may then link with a customer service block (107) in an export process (106) which exports necessary information and/or payment to the appropriate issuing authority and any other related systems of the fleet owner. The customer service block (107) provides for renter interaction with the owner related to the citations and the renter's responsibility to the owner for that citation.

As should be apparent from FIG. 1, these functional blocks also interact with three other functional blocks which, while not as directly operating on the citations, are designed to aid in the management of citations for the fleet. These can include an agency block (111) allowing the system to be deployed over a distributed network in such a manner that each individual owner can include specific components of the system required for those types of citations most common in its jurisdiction or its own internal requirements. A letter templates block (113) provides for formatting and arrangement of output to make sure that output conforms with necessary standards, local regulations, or requirements of issuing authorities, and a management tracking block (115) which provides for overall reports, overview control, and other managerial information to determine the operation and control of the system as well as its effectiveness.

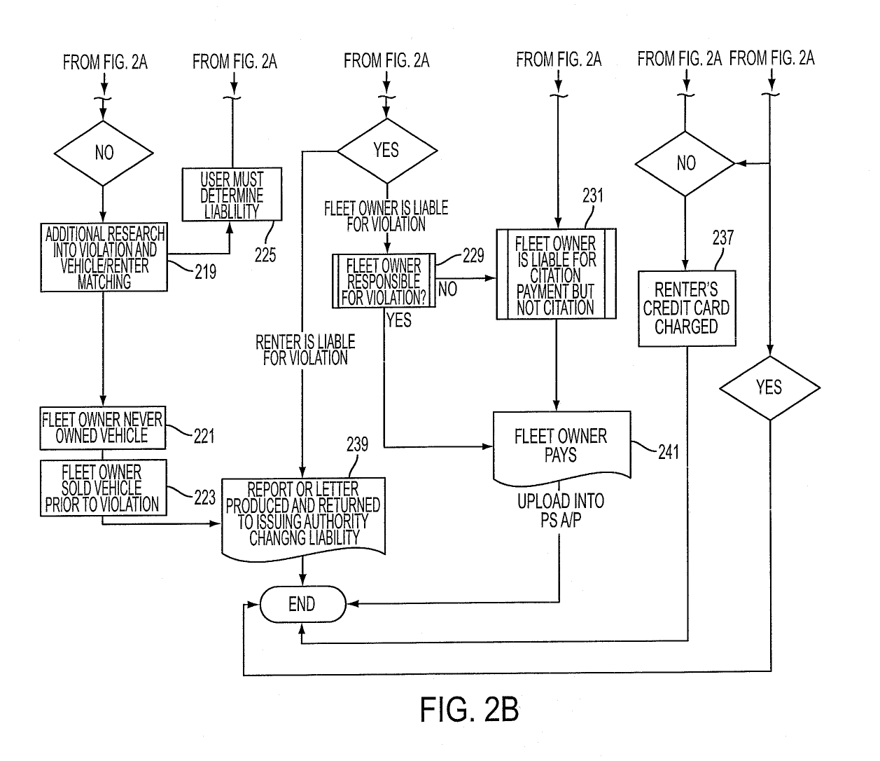

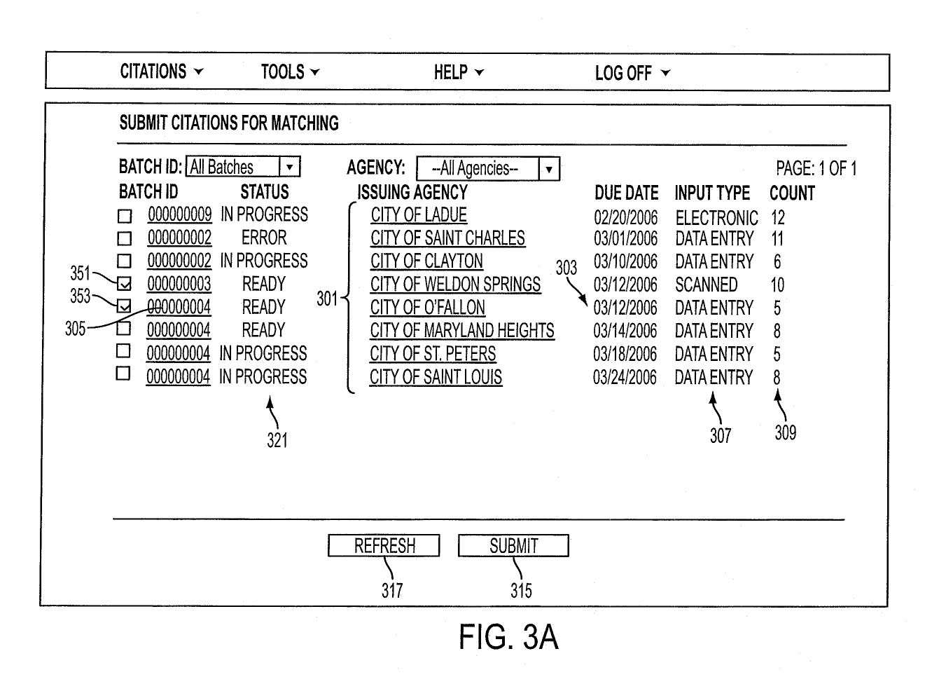

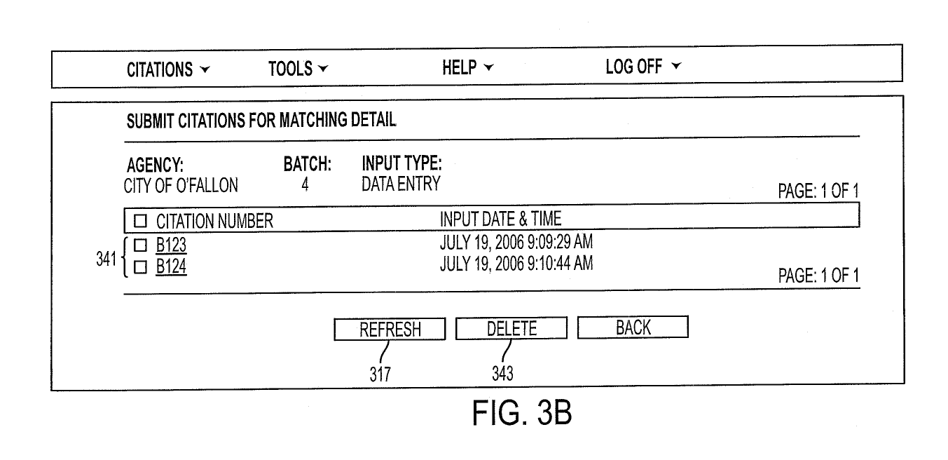

The block diagram of FIG. 1 provides for some detail of the steps of operation of each of the block processes. These processes are generally shown in more detail in the flowchart of FIG. 2. In FIGS. 3-9, the processes of FIG. 2 are shown via various screen shots showing how data may be input or manipulated by a user interacting with the CMS operating on a computer. FIGS. 1-9 will all be discussed in conjunction with each other due to overlay in their visualization. This discussion will focus on the typical operation of the system in a rental vehicle environment where the fleet is owned by an owner which loans the vehicles to renters for various contractual times. However, while this is provided as an exemplary embodiment, use in such an environment is by no means required. In an alternative embodiment, for example, a renter could be an employee and instead of a rental contract, there may be an agreement, policy, or other contract (and related documentation) related to their use of fleet vehicles.

The CMS may be owned by the fleet owner who will be controlling the operation of the CMS or by another entity providing the CMS or results of the CMS as discussed above. Generally, the CMS operator will be the rental vehicle company, who will have the CMS running on a computer system or network and available to users who are generally employees who have been trained in its operation. In an alternative embodiment, any third party agents may use the CMS either for their own benefit or the benefit of the fleet owner. For example, the renter, an insurance company, the issuing authority, a service provider, or any combination of these or other third parties may use the CMS in addition to or instead of the fleet owner. The CMS will generally be provided over an internal company network in a distributed fashion so that each user will be able to use the system for citations issued to each individual depot. In particular, each depot will handle citations which are generally from a limited number of local jurisdictions, and a few which may be from outside the general geographical area. In this way, they will generally only be operating on a subset of all citations provided to the fleet owner. However, this is by no means necessary and the CMS may be set up at a central location to process all citations.

The CMS is ultimately seeking to match a renter to a citation, however, it will often times use a default of matching a contract to a citation as a contract is associated with a unique renter. However, it is possible that the same “renter” may have actually entered into multiple contracts at a number of different times with the same owner for different vehicles. So, while each contract has a unique renter, a renter does not necessarily have a unique contract associated with him. In this way, a renter who has two or more citations related to different contracts is generally treated as two different matches by the system. This arrangement is not required but generally provides for simpler management. Generally, the contract will specify that the renter is responsible for any citations issued to the user for their operation of the vehicle during the time period of the contract making the renter responsible for any citations received during the time of the contract whether they were operating the vehicle or not, barring certain exceptional circumstances.

The term “citation” is used herein to refer to any alleged violation of a law or rule related to the operation of the vehicle. Principally. this disclosure is interested in citations which are issued based on the vehicle as opposed to the actual operator. That is, the citation is based on observed actions of the vehicle, not necessarily linking those actions to the individual who was operating the vehicle at the time the violation occurred. Such citations will generally be of four types: moving, parking, toll, and upkeep. Moving violations comprise such actions as exceeding the posted speed in an area, entering an intersection when a stop light was red, or other related violations having to do with operating a vehicle in motion in a particular manner. The moving violations of interest here will generally be those that can be detected by automated systems such as cameras and which use video or still photography as evidence. Further these will generally be relatively minor violations of the type where most commonly a fine is assessed and simply paid from the violation. Challenge to the validity of the citation is relatively rare and the punishment is of limited scope.

There also may be parking violations which would involve leaving the vehicle in an area where it is not supposed to be left, such as in front of a fire hydrant or without paying a posted meter. This type of citation may be automatically issued or issued by a parking enforcement officer. While a moving violation will often result in the owner of the vehicle receiving the first notice of the violation directly, a parking violation is often left with the vehicle. In this case, direct notification may not come to the owner of the vehicle until an initial period to pay the fine has elapsed, this may mean that a penalty is already being imposed for failure to resolve the issue.

The third common type of citation is a toll or tax citation. This can comprise utilizing a toll road without paying the appropriative toll or otherwise operating the vehicle in a place where a cost is required and has not been paid. This can include such things as not paying a congestion tax or fee for operating a vehicle in a particular area or at a particular time.

The fourth and final common type of citation may relate to those which are specific to the upkeep or other aspect of the vehicle itself. For instance, if the vehicle violates local requirements for safe operation (such as having burned out lights) or if the license plate has not been correctly renewed. While these types of citations are managed by the CMS, these citations generally have little to nothing to do with the operator of the vehicle but actually do relate to the owner of the vehicle.

While the above does not comprise a complete list of the types of citations which may be managed by the CMS, it does discuss those that are more likely to need to be managed as they are assessed referencing the vehicle, not the operator, and therefore are more likely to be received by a fleet owner. More major moving violations and other types of more major violations are generally only issued in a situation where a law enforcement officer not only identifies the vehicle involved in the violation, but also identifies the operator with specificity. In these situations, a fleet operator will often never receive the citation because the issuing authority will already have been provided with identifying information of the operator at the time of the violation and the issuing authority will know that the vehicle was part of a fleet and being operated in accordance with a contract or other arrangement. Therefore, the issuing authority will pursue the operator directly as the violation is their responsibility.

In operation of the CMS, a plurality of citations will exist which are associated with various vehicles in the fleet. Some of those citations may have been for violations which are the responsibility of the operator while others will not be. Generally, the citations to be managed will not have been issued directly to the operator, such as would be the case if they were pulled over by a law enforcement officer, but will have been issued to the vehicle and thus the fleet owner as the default operator of the vehicle. The renter may or may not know of the citation. However, whichever is the case, the renter will generally not have resolved the citation with the issuing authority prior to the issuing authority wishing to communicate knowledge of the citation to the vehicle owner. This may simply be as part of a routine or scheduled notification of citations, or may be because a citation has been unpaid for a period of time.

To begin the process illustrating the operation of the CMS, there is first issued a citation in step (200) listing the rental company or agency as the responsible party due to their ownership of the vehicle. This citation is then provided to the rental company/agency as owner in step (201). Received citations may be received in any format from any number of issuing authorities. The most common formats are either electronic (203) or paper (205). The preferred electronic format utilizes a computer readable list providing the necessary information of the citation along with any other voluntary information which may be provided by the issuing authority in conjunction with the citation. Citations are preferably provided as a batch for a particular issuing authority and time period. The computer readable list is in a format and layout agreeable to both the fleet operator and issuing authority so that each entry for each citation includes expected information. Generally, the information which needs to be provided for the CMS to handle the citation in an automated fashion includes: The issuing authority, the nature of the citation, identification of the vehicle which was cited, the amount of the fine for the citation, and the time that the citation was issued.

In the event that this information is not provided electronically to the owner, the owner may place the material from whatever form it is received into electronic form. In particular, this may be done by scanning of paper documents into an electronically readable format in step (207), by human entry of information from a document into an electronic format in step (209) or any other manner, or any combination of these.

Once the data is in electronic format, it is ready to be used by the CMS and is generally placed in one or more databases of information as indicated in step (211). The placement of data in electronic format generally comprises the data being provided to the CMS system. That is, at that point in time the CMS has access to the citation information. To begin operation on citations in the CMS, a user will generally log into the CMS so as to use the CMS. In an embodiment, the CMS is able to provide specific settings for the user based on where the owner is or their preferred settings. For instance, the CMS may configure the screen displays (which are in English in the FIGS.) to use a local language, alphabet, or symbols of the user. Further, certain fields may be adjusted based on local norms—for instance license plate numbers may be provided with hyphens in certain states and without in others. This customization makes the system easier for a user to interact with and in an embodiment does not generally alter the underlying structure. The local settings may be maintained in the agency block (111) in an embodiment. In an alternative embodiment, the system can be entirely automated, and not require user login, but some human oversight is generally preferred. Such login may use any method and manner of allowing access to a computer system as understood by one of ordinary skill in the art and will generally require the user to identify themselves to the machine in a manner such that the machine identifies them as an authorized user who is allowed to utilize the system. The user will begin by indicating to the CMS to submit citations available to the CMS for matching by the CMS so that the CMS can work on them. The above functions are generally the functional element of the receiving block (101) from FIG. 1.

Screens indicating how material can be reviewed and submitted for matching is shown in FIGS. 3A and 3B for an exemplary owner located near Saint Louis, Mo. In FIG. 3A there are shown a number of citation batches (301) that are currently accessible by the CMS and which have not yet been reconciled and are for jurisdictions in the Saint Louis area. Each batch (301) shows the municipality from which the citations in the batch were issued. The screen also shows some general information about the batch such as the earliest due date to pay fines (303) in the batch, an identifier (305) associated with the batch, a type of entry associated with the batch (307) indicating the manner in which it was placed in the database, and a status (321) associated with importing the data from the batch. The entry may also indicate the total number of citations in the batch (309). The user will select one or more of these batches (301) to be matched in step (207) (in this case the collections indicated as (351) and (353)) based on the work that the user wishes to do at this time. The selection may be of any number and will generally relate to both what the user wishes to match at this time, as well as other considerations such as age of the citations and the like. Once the user has selected the batches (301) of citations to match, he will click the submit button (315) which will trigger the CMS to begin to attempt to match them with contracts.

Alternatively, the user may review the specific citations in the batch, such as by clicking on the Batch ID (305). This would take the user to a screen such as that shown in FIG. 3B where the user can review the specific citations (341) included in the selected batch. They may then choose to return to the screen shown in FIG. 3A if everything appears to be in order or may delete various citations from the batch for whatever reason by selecting the citation and clicking the delete button (343) in FIG. 3B. In both screens there is provided a refresh button (317) which may be used to update the screen to reflect changes or to improve readability.

Upon matching being commenced, the CMS will take various pieces of information from each individual citation in the selected batches and will attempt to correlate that information with information on contracts of the owner in step (213). The contract information will generally comprise additional information stored in a memory accessible to the CMS such as a database to which the CMS has access. The contracts will generally be stored in electronic form and are also searchable.

Generally, the first stage of matching will involve the system pulling various pieces of information from each of the citation records and then attempting to correlate each citation with a contract that was in force at the time that the citation occurred for the cited vehicle.

Generally, in the matching step (102), the CMS will take the vehicle identifier and the time of the citation from an individual citation record. The time may be a specific time reference to an instant in time, or any other recognized division. For instance, the time may be down to a sub-second, second, minute, hour, day, or even week or month. However the latter are much more unlikely than references with hour or minute calculations. The CMS will then compare this information against a database of information providing for the time periods each contract was in force looking for a match. In the event that the time and other information is specific enough and happens to clearly relate to a single contract, a match can be made for the citation.

In most situations matching will be able to be performed in a completely automated fashion because the citation will match uniquely to a single contract. However, if the information is not specific enough (for instance, on the time when the citation occurred versus when the contract started or ended), it may not be possible to match up the citation to a unique contract automatically.

The unique matching is a first facet of the automatic matching process. Generally, it will be the case that the citation relates to a particular renter's operation of the vehicle and it is undesirable to provide a citation to a renter who is not actually responsible for the citation. Because of this, if the automatic matching process is unable to uniquely match up the citation with a contract, the CMS will generally return that the citation is unmatched and request further instruction for how to handle it.

To show the nature of a unique match by example. To begin, there is a contract which indicates that John Q. Renter rented the vehicle identified by Serial # 12345678 from Mar. 3, 2006 at 3 pm until Mar. 5, 2006 at 2 pm. If a citation was issued for vehicle Serial # 12345678 on Mar. 4, 2006 at 10:31 am it is quite clear that John Q. Renter was responsible for the vehicle at the time of the citation and that therefore a unique match between contract and citation occurs as the vehicle is uniquely matched to a single contract for the vehicle and the time of citation occurred within the time period of the contract.

The case where matching of the vehicle to the specific contract which was in force at the time of the citation is the simple case, but will generally be true for most citations. If the vehicle is not being operated it should not be receiving a moving citation, and the vehicle will generally not be operated except when it is under contract unless it is being operated by a representative or agent of the fleet owner, which would generally make the fleet owner responsible for the citation. However, other citation types could be relatively common even when the vehicle is not under contract

However, even recognizing that most citations will be issued during a contract period, sometimes the automated matching will not be able to be completed as a unique contract may not match up with the information in the citation. For instance, continuing the above example, if Jane W. Alsorenter rented the vehicle after it was returned on Mar. 5, 2006 at 3:00 pm and a citation was issued that simply stated the violation occurred on March 5. It is unclear which of the two renters on that day actually committed the violation. Still further, as the vehicle was unrented from 2:00 pm until 3:00 pm depending on the nature of the violation it may be possible that an employee or agent of the owner actually committed the violation. For instance, if the citation was a parking citation for a location near the fleet owner's business, it is possible that an employee of the owner actually committed the violation when transferring the vehicle between the two renters.

In these and other situations, the automated matching component (102) of the CMS will generally be unable to uniquely match the citation to a contract. However, in most cases it generally will be able to. For example, in the above situation if the second citation (which only listed the day but not the time) had been issued March 4 instead of March 5, the citation could still be uniquely matched up to a contract as John Q. Renter was responsible for the vehicle all day on March 4. The automated matching process, therefore, generally provides for improved efficiency in handling citations. As will be discussed below, in the event that all the citations can be automatically matched, then the system can also automatically generate the necessary output to handle them either with or without human review of the matching.

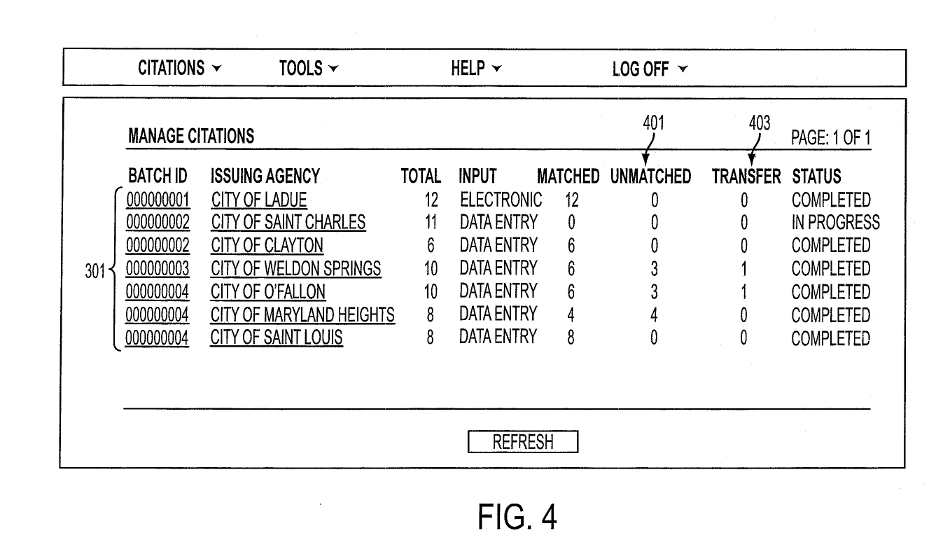

Before we get to output, however, another facet of an embodiment for the CMS is that it can provide for a user interface to help the user reconcile citations which the CMS could not automatically match up to a contract uniquely. It is determined in step (215) whether the automated matching was completed for a specific citation (i.e., whether there is a unique match between the citation and a contract in the database). The screen of FIG. 4 shows the results of automated matching. As should be clear, some batches (301) are completely matched (as indicated by “O's” in the unmatched column (401)) while other batches did not completely match up. The transfer column (403) shows how many of the unmatched citations require transfer to a different depot or even owner as the vehicle was not controlled by the depot currently performing the matching at the time of citation.

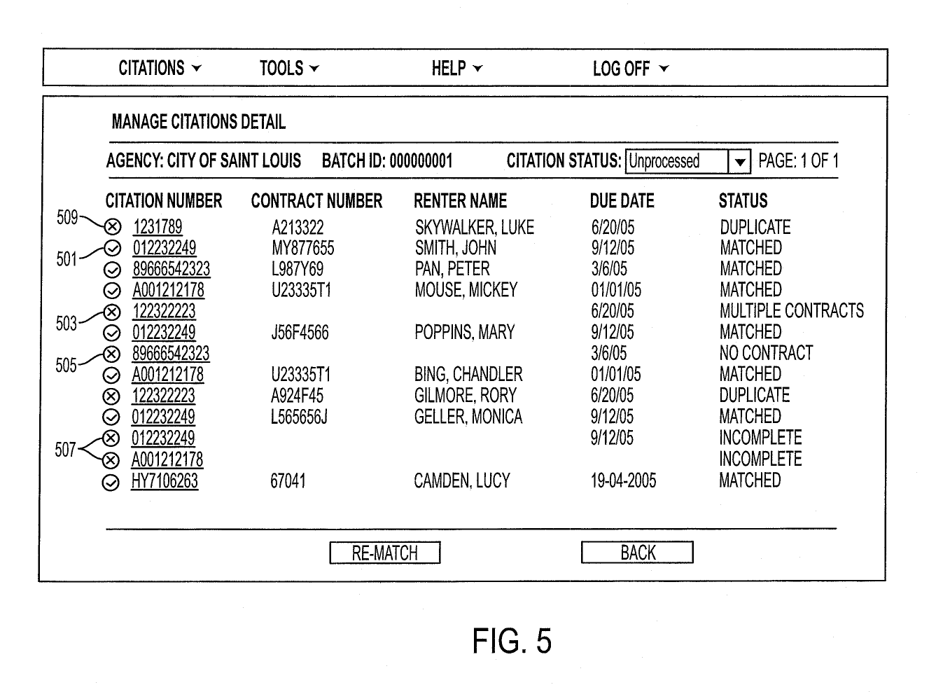

If the batch is completely matched, the user need take no action as indicated by the yes arm (217) of FIG. 2 as the system prepares to deal with the citation. However, if the citation is not matched, the user will generally select the batch to review the specific unmatched citations in the batch in step (219). A review screen for a partially resolved citation batch is shown in FIG. 5. In this batch a number of citations, such as citation (501), have already been matched up via automated processes to a single contract in such manner that there is no question as to the contract the vehicle was under at the time the citation was issued. These are indicated by the check marks.

However, in this example, a number of other citations, such as citations (503), (505), (507), and (509) are indicated as having not been matched with particularity. In the embodiment of FIG. 5, these types of unmatched citations are indicated by the “X” indications. There also is provided a quick indication of why the system was not able to complete an automated matching to a particular contract. This can be for a variety of reasons but may be because, for example, (a) the time specified on the citation could be associated with multiple contracts (such as in the above hypothetical), which is the case for citation (503), (b) there may not have been a rental contract in force at the time that the citation was issued as is the case for citation (505), (c) the vehicle may not have belonged to the rental company at the time the citation was issued (either because it is not their vehicle or because it had been sold prior to the citation), (d) the information provided in the electronic version of the citation may be incomplete in such manner that a necessary piece of information is missing to provide for the matching as in citations (507), or (e) the entry is duplicative of a previously entered citation or is a reminder or similar notice as is the case for citation (509). In this final case, a unique match may have actually been made, but the citation may not need to be considered further.

When there is no contract associated with the time of the citation, as in citation (505), this may be treated as not being uniquely identified, or may actually be uniquely identified as “matching” to the owner. In the event there was not a contract in force, it is likely the case that the rental company was directly responsible for the citation. For instance, the renter may have returned the vehicle and the rental company was in the process of preparing the returned vehicle to be available for rent, or an employee of the owner may have illegally parked the vehicle. In another embodiment of the CMS, this citation may then be set up as uniquely associated with a “contract”, and matched by being uniquely associated with a time without a contract. A similar situation may occur if the type of citation (for instance, an expired license plate) indicates that the citation is the owner's responsibility.

In situations where the vehicle was not owned by the rental company at the time of the citation, these may be matched up by manually or automatically determining who the vehicle was sold to in step (223), or simply that the vehicle was never owned by the owner in step (221) and providing the necessary information to the issuing authority. Generally, such a situation will result in a transfer of liability as the fleet owner was not responsible for the vehicle at the time of the citation. In still other situations, it may be necessary to request additional information from the issuing authority in an attempt to make the unique association as in citations (507).

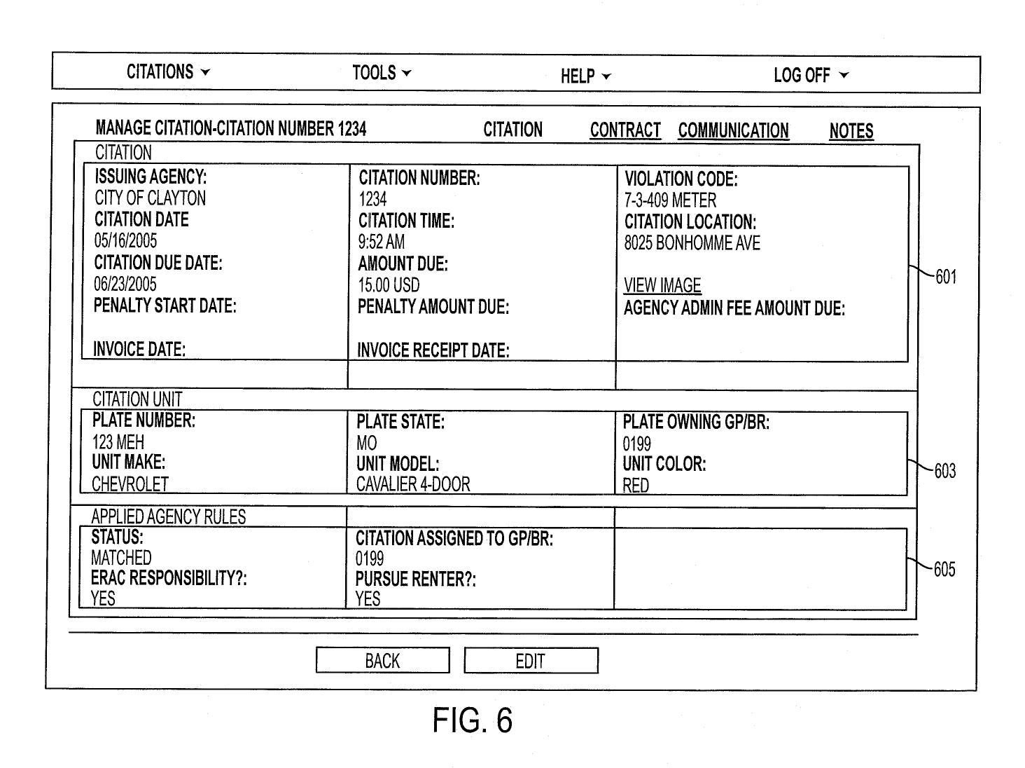

In step (225) where the citation does relate to a fleet vehicle which has not been sold, the user will generally go through and review unmatched citations in an attempt to match them, if possible, or otherwise assign them to a particular unmatchable class or eliminate them from further actions. Specifically, if a match cannot be made, the user could consider the citation to be unreimbursable and assign its fine as a cost. Alternatively, to assign the citation, the user may need additional information on the citation and the situation. They may determine this by selecting the particular citation to load up details. If additional information is received, it can then be loaded to supplement the original entry. Such details are shown on FIGS. 6-8.

The idea of having the user match difficult citations to a contract by hand allows for the system to digress more complicated situations to a human user for resolution. While this methodology is generally preferred, it is by no means required and in an alternative embodiment, citations which cannot be automatically matched may be simply assigned as the responsibility of the owner either as the owner's responsibility or as uncollectible overhead. Human review can allow the user to review the automatic matching for possible errors or to provide information to the renter about the citation or match as part of the customer services block (107). In an alternative embodiment, the CMS, upon being unable to match up a citation with a contract based on the initial information, may examine additional information automatically and repeat the search to see if the citation can be uniquely matched.

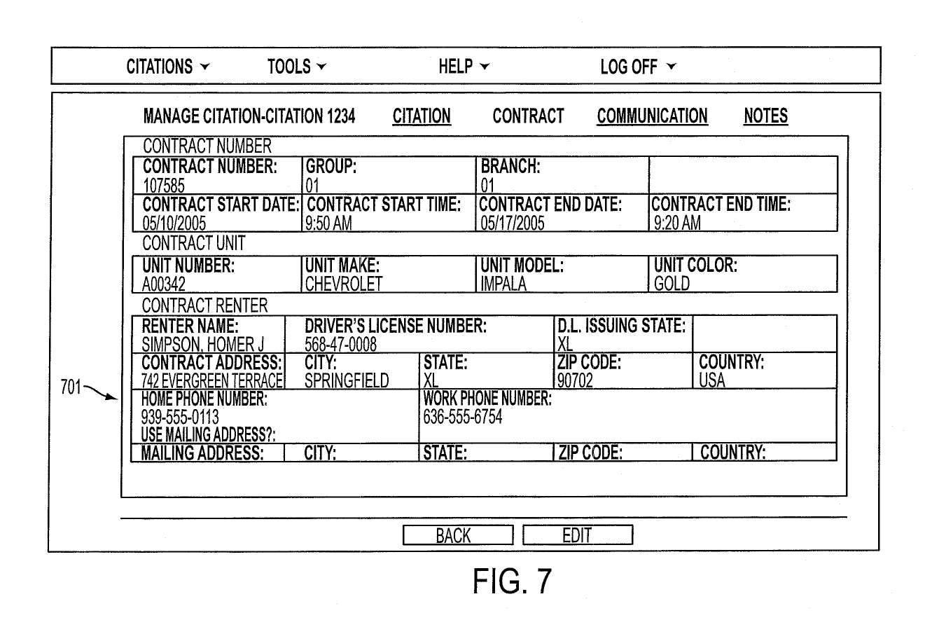

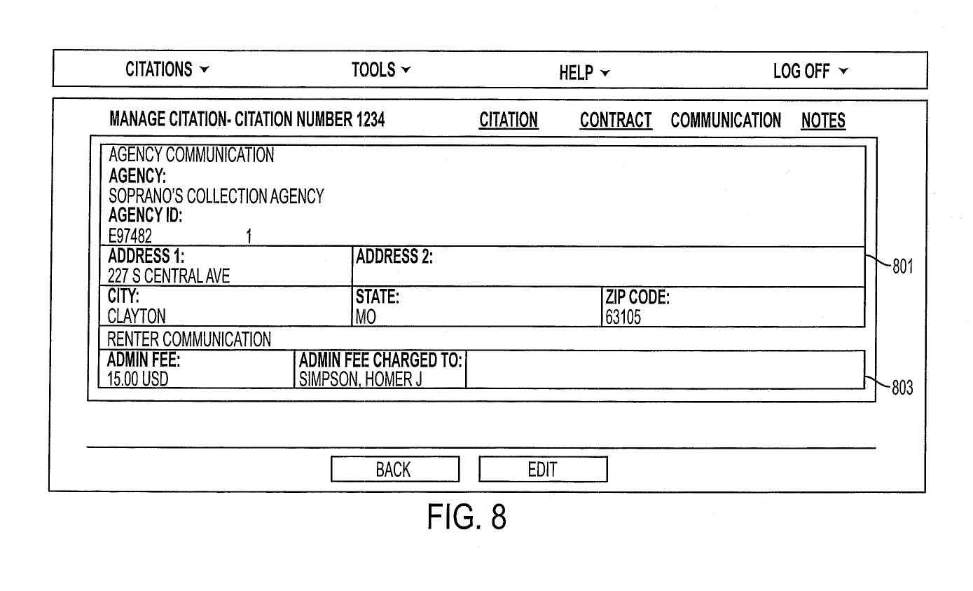

In the human user case, when the human user clicks on a citation they obtain screens that have additional information which may be of use to them in trying to uniquely match the citation to a contract or renter. In particular, as shown in FIG. 6, details related to the citation (601), the vehicle (603), and specific agency rules (605) are provided at least in so far as the machine could determine them. The human user may be able to see a particular relationship in this information that the machine could not. For instance, the user may recognize that the vehicle is a van, and the particular depot does not rent vans implying that the system may be looking in the wrong place for information or that an element of information on the citation may have been entered incorrectly. The user can also review specific details on the contract(s) as shown in FIG. 7. This can be useful to make sure that the correct contact address for a renter is being used. That is, the contract information (701) relates to the renter, and not to, for instance, a hotel the renter may have stayed at. The user may also review information about the issuing authorities in FIG. 8 including if they use collection agencies (801) or if the citation includes an administrative or other fee (803) in addition to the fine. This information may indicate that the specific details of the issuing authority which may correlate to a likelihood of error, or who should be contacted for additional information.

In order to try and match the citation uniquely, the human user can also review information in other databases to determine if the situation can be resolved to a unique contract as part of step (225). This may involve searching another database (such as to determine to whom a vehicle was sold, for example, if the date occurs subsequent to the fleet owner's ownership of the vehicle) or may involve various analysis of likelihood or even of willingness to assign the citation to a particular contract. For instance, if one contract had the vehicle until 11 pm on a particular day and the next checked it out immediately thereafter, but the violation occurred in a location 200 miles from the fleet owner, one may be able to deduce that the violation was almost certainly performed by the first renter, as the second renter would be unlikely to have reached the location in that same day.

Similarly, if a particular violation can only occur at particular times (for instance, a carpool lane violation) and one contract was in force during all of these possible periods, even if the citation does not include the time of violation it may be possible to deduce the renter responsible for the citation. Similarly, if citation fine amounts change based on time, it may be possible to link the citation to a unique contract even without a time being specified. In still further situations, there may not be a unique contract, but there may be a unique renter. For instance, a user may have returned the vehicle on one contract, but immediately rerented it. In this case, a citation may not be able to be uniquely matched to a contract, but can be uniquely matched to a renter.

In other cases where it may be difficult or speculative to deduce the correct renter to whom to assign the citation, the user may simply assign the citation to the fleet owner, effectively saying that the citation is not reimbursable either because it appears to have been the owner's action that resulted in the citation, or because it is too speculative to attempt to assign the citation. In this situation, the citation would generally be paid by the owner.

Regardless of what information is desired by the user to perform manual matching, this information will generally be available via the computer on which the user is interacting with the CMS. In an embodiment, the CMS actually provides for linked connection with other databases and/or search engines so that the user can access data either available as stored by the fleet owner or publicly available. In a still further embodiment, the CMS may be interlinked with other databases outside the control of the fleet operator to provide for information. For instance, the CMS may provide the operator with links to public records related to vehicle registrations, or to electronic phone books or other correspondence aids. In all cases, it is generally preferred that use of databases via the CMS utilize regular interface structures to provide for information in a more automated and template pattern.

As should be apparent, in another embodiment of the CMS, it is not necessary to involve the user review at all. In this situation, the CMS can automatically review all citations and attempt to uniquely match them. If the citation can be uniquely matched to a contract, then the process continues as discussed below to exporting, which is also automatic. In the event that it cannot, this citation is simply assigned to the owner. In some situations, this arrangement is preferable as it can eliminate any non-automated segment in the work block (103) of FIG. 1.

Regardless of what is done, eventually all citations will be considered reconciled. This will either be because they have been matched up to a unique contract (or renter), “matched” to the owner, or indicated as being unable to be matched up. Once this is done, it is now dependent on the specific requirements of the issuing authority as to what is done next and the system moves to the export block (105). Generally, there are two possibilities of what the owner has to do with regards to citations and they depend on jurisdiction. In some jurisdictions, the transfer of liability by a fleet owner to a renter is allowed in step (227). In this case, the fleet owner will need to provide notice to the issuing authority (or their authorized agent) that liability is to be transferred in step (239) and the information necessary to transfer liability is also provided to the issuing authority. At which point, the liability of the fleet owner is removed and the issuing authority will pursue the listed liable party directly.

In the transfer of liability situation, the letter templates block (113) of the system can provide for necessary information based on rules, procedures, and policies of the local jurisdiction of the issuing authority. The local agency block (111) can provide for an indication of any specifics of the local agency in transferring liability including templates, formats, types of accepted proof, or other local jurisdiction information related to rules, procedures, and policies. This information can in fact be provided and added in the initial matching process. For instance, the CMS may match the citation to a particular contract, the CMS may then utilize information from the citation or even the contract to determine how the issuing authority wishes this issue to be handled. In particular, it can gather the necessary information from the database related to the contract and prepare the document and all necessary details to provide the information to the issuing authority. The CMS may also gather other stored information required by the issuing authority. In an embodiment, for example, the CMS may access stored images of original paper rental contracts. It can then printout or otherwise provide a copy of that stored image to serve as verification of the original terms of the contract and that the contract appears, on its face, to be valid and that transfer of liability is warranted. The CMS may also select a font size, paper size, correspondent, or other information from a database of local jurisdiction information which may be part of agency block (111).

The document for transferring liability need not be paper. Depending on requirements of the issuing authority, the information collected by the CMS may be provided in an electronic document. Therefore, the document of transferability could comprise a single collated electronic format to the issuing agency all the way to an individual hardcopy letter along with any necessary attachments for each citation, or any format combining or between such notification methodologies. Once this information is loaded, the CMS can populate the necessary letter template, electronic file, or other structure with the information from the citation matching. It also can retrieve copies of any other documents which it may have access to that need to be placed with the letter or other transmission. Preferably, all of these steps can be performed automatically (that is, without user intervention) allowing them to be accomplished quickly and at low cost.

In the event that the document is electronic, the CMS may then automatically initiate the transmission providing the necessary information to the issuing authority. If paper formats are required, the CMS can commence printing of the necessary documents, along with any supporting documentation that it has access to. This again helps to automate the system because even if letters have to be signed or otherwise handled by an individual, they may be able to go through them in a rapid fashion knowing that all necessary material for each one is already present and that the letter meets the necessary formats required by the issuing authority. This arrangement allows for letter sending to be a routine and relatively simple process. Either methodology would comprise the export process (106).

While the transfer of liability is a relatively simple outcome, some issuing authorities may not wish to get involved with a transfer of liability and will look to the owner of the vehicle for payment of the fine even if the owner can prove it was not operating the vehicle. In these jurisdictions, the owner may be responsible for payment of the fine and any related fees but then could recoup the cost of it from the renter depending on the terms of the rental contract as shown in step (231). In this embodiment, the payments which are due may be gathered together and formed into a document to be provided to the owner's accounts payable department for payment in step (241). Again this may be in any form depending on what is required. It is preferred that the payment can be performed in an essentially automated form whereby money is simply paid to the issuing authority to remove liability for the listed citations. However, it obviously is important that the owner make sure that they know which citations have been paid by any payment.

In a still further embodiment, the owner will have prepaid for fines in advance or have an account present at the issuing authority. In this situation there is no need to make arrangements to pay the fines, but rather the payment will need to be reconciled with amounts taken from the prepaid account for application against a particular renter. Additionally, such an account would need to be replenished periodically. This situation can be particularly beneficial for both the owner and the renter for issuing authorities that charge late or administrative fees, in addition to fines. For example, the owner may have a prepaid account with a toll authority. Every week the toll authority deducts from an account the total amount of all tolls incurred by the owner's vehicles. The toll authority then sends the cost, along with the indications of payment, to the owner who replenishes the amount in the account after the citations are matched. If the toll authority normally would assess fines for late payment, this avoids those fines as there is no late payment because the cost was prepaid. That is, the toll authority may normally assess a fine for late payment due to the administrative cost of having to pursue the vehicle operator for payment. In this case, that cost may not be assessed. In a still further embodiment, a renter such as a corporation which deals with a number of citations may have an account with the fleet owner which allows the fleet owner to pay the fees and fines immediately and then seek reimbursement of the account.

Regardless of how the fines are actually paid, the owner may wish to recoup the cost of the tolls and any fines from the renter. This may be done by sending a document to the renter that a citation was received and paid and that the renter is responsible for the cost of the citation, plus any applicable fees as indicated in step (233). With regards to fees, these may be late fees or other fees charged by the issuing authority, or there may be fees specifically added by the owner in an attempt to recoup its costs of collection as embodied by the CMS system and the users themselves. Alternatively, the document can instruct the renter how to pay the issuing authority directly.

In order to recoup the costs of having to pay fines not dealt with by the renter, the owner may provide a document, whether paper, electronic, or other form, to the renter requesting reimbursement from the renter for the fine, issuing authority fees, and/or fees of the owner related to costs of owning or operating the CMS in step (233) or requesting payment of the fines or fees directly. This may be a request to provide payment or may be an indication that if payment is not otherwise provided, an account, such as, but not limited to, a credit or debit card, a bank account, or another source of funds, for instance the one originally provided for the rental transaction, will be charged on a particular date in the listed amount and may be provided automatically. This document may be generated automatically or semi-automatically in similar fashion to how the transfer of liability correspondence can be generated. This generation may also use any or all of the systems and methods discussed for the transfer of liability system for local rules, procedures, and policies, better templates, or anything else.

In order to facilitate customer service, the system may be setup in such a fashion that payment is not actually provided to the issuing authority by the fleet owner until the renter either pays the citation cost in step (235) to the fleet owner, the period to pay the citation runs out and the citation is paid by the owner, or the renter's account (such as a stored credit or debit card) is automatically charged because the renter has not otherwise contacted the owner about payment for the fee in step (237). These systems can help avoid either the owner or renter being responsible for any late fees. The document may also provide information on how to pay either the fleet owner, who will then in turn pay the issuing authority, or to pay the issuing authority directly. The document may also include procedures for notifying the fleet owner of a direct payment to the issuing authority to meet the renter's responsibility for the payment. In addition to providing the document to the renter, the information relevant to the payment may also be transferred to another computer system, such as, but not limited to, an accounts payable portion of an accounting system of the owner which can then treat the payment as any other due or over due account and handle it as such.

In some situations, the CMS may process citations for various types of violations that are not the responsibility of the renter. For instance, a citation for having a vehicle without a timely filed renewal of the license plates may have been issued while the vehicle was under a rental contract. This violation, however, is specific to the owner of the vehicle (not to the operator) and relates to their violation of the proper vehicle licensing laws. In this situation, the CMS also may recognize that for this type of violation the contract is irrelevant and may override the matching of the citation to the contract in force at the time by simply assigning the citation to the owner and having the fine paid in step (241).

Even with payment by the fleet owner being a default situation to avoid imposition of other fees, to try and insure that the costs of the citations are recouped there may still be a need for additional customer service components of the system as indicated by customer service block (107). In particular, the CMS can have the individual citation information modified, even after the notice of payment, and or payment of the citation by the owner using the screens of FIGS. 6-8. In this way, if the renter contacts the agency requesting that they pay the charge in a manner other than the default provided to them (step (235)) they can do so and the citation can be cleared. If such action is taken, the user of the CMS may indicate to the CMS that the citation has been paid using an alternative method such as by editing the record to indicate payment.

It should be apparent that while the discussion above goes into many of the core processes of the CMS other processes can also be included in different embodiments. Further, the CMS is designed to automate any or all of the steps of citation input, citation matching, and export. Therefore, depending on the embodiment, any or all of the functional blocks of FIG. 1 can be performed entirely by machine. Generally, the more functions performed by the computer, the lower the cost of managing the citations, but the more citations that will be unmatched and therefore the responsibility of the owner. Hence, it is up to the owner and fleet owner to decide the optimal level of automation for their cost and service requirements.

In an embodiment, it is additionally desirable to maintain management records of how the CMS has been used. This is performed by management tracking block (115). Tracking may take many forms but generally may comprise the ability of the CMS to collate data on its own actions. For instance, the CMS can be provided with functionality that allows it to provide calculations related to the percentage, or other indicator, of citations which are automatically matched with the database of contracts, total matching, or other statistics. It may also or alternatively provide for indications of how much of the citations costs are transferred or recouped or other types of statistical evaluation or other management tools.

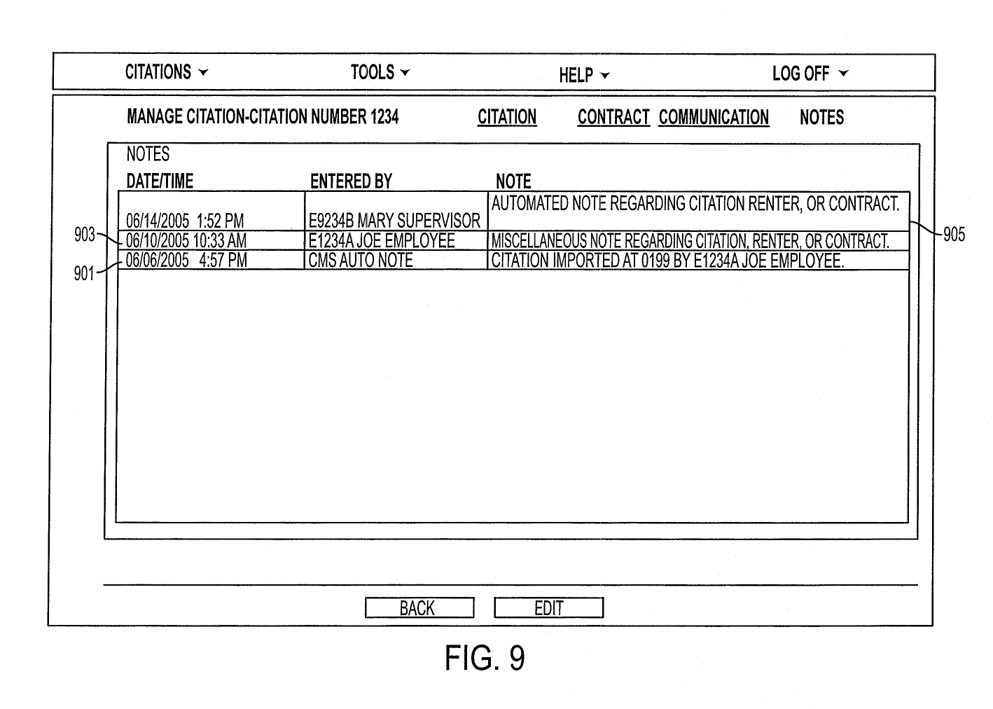

In a still further embodiment, the CMS can also be provided with additional security to try and inhibit tampering. As was discussed previously, the user will generally be required to log into the system which serves to identify them and their actions to the computer. There also may be maintained a log of what occurs in a particular file to provide for records of activities and for the performance of certain machine actions. This log may also help with the customer service block (107). An embodiment of such a log is shown in FIG. 9. The CMS may also include functionality to address potential revelations of confidential information and other privacy issues as part of its security.

In this log, various machine actions, such as the import of the citation (901), are recorded and referenced in conjunction with time and date stamps to provide records of automatically undertaken functions. Further, there also could be indications that a user performed a certain action which could potentially result in tampering or which are needed to reconcile later potential problems (905). Still further, the log section could allow for a user to simply enter notes or other comments (903) which are desired to be available to a later user accessing the same citation record. For instance, the user may voluntarily place an indicator that the renter had called to dispute the alleged citation saying that it was not committed by them. This information may then be used, such as in a case where multiple contracts were present, to alter the matching or to provide for a methodology to remove liability from particular renters for customer service reasons.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A method of managing citations for a fleet of vehicles, the method comprising:
having a fleet owner responsible for a fleet of vehicles and a citation-issuing authority;
providing a computer;
said owner receiving, from said issuing authority, a plurality of citations, each of said citations referencing a vehicle in said fleet and a time of said citation;
placing said citations in computer readable form;
said computer accessing a database of contracts in computer readable form, said database including a plurality of contracts, each of said contracts in said plurality indicating a period of time during which a renter was responsible for said vehicle; and
if said time of a first citation is wholly within said time period of a first contract:
said computer automatically matching said first citation with said first contract;
said computer automatically generating a document, said document being sufficient to transfer responsibility for said first citation to said renter; and
providing said document to said issuing authority.

2. The method of claim 1 wherein said step of placing is performed by said issuing authority.

3. The method of claim 1 wherein said step of placing is performed by said owner.

4. The method of claim 1 further comprising the step of, indicating that responsibility should be transferred prior to the step of said computer automatically generating said document.

5. The method of claim 1 wherein if said time is not wholly within said time period of any contract within said plurality of contracts said computer indicates that a match was not found and a human being attempts to match said first citation.

6. The method of claim 5 wherein, if there is no contract in said plurality of contracts which has a time period which overlaps with said time, responsibility for said citation is maintained with said owner.

7. The method of claim 5 wherein, if there are multiple contracts in said plurality of contracts which have a time period which overlaps with said time, responsibility for said citation is maintained with said owner.

8. The method of claim 1 wherein, if there is no contract in said plurality of contracts which has a time period which overlaps with said time, responsibility for said citation is maintained with said owner.

9. The method of claim 1 wherein, if there are multiple contract in said plurality of contracts which have a time period which overlaps with said time, responsibility for said citation is maintained with said owner.

10. The method of claim 1 wherein said step of placing comprises at least one of:
scanning of paper documents, manual entry of information from documents, or use of a direct electronic input.

11. The method of claim 1 wherein if said time of a said first citation is wholly within said time period of said first contract: said computer also automatically generates a second document, said second document indicating that said renter is responsible for paying said fine

12. The method of claim 11 wherein said computer automatically charges said renter for said fine at a time after said second document is provided to said renter.

13. The method of claim 1 wherein said fleet of vehicles are rental cars and said owner is a rental car agency.

14. The method of claim 1 wherein said matching is verified by a human prior to the step of said computer automatically generating said document to transfer responsibility for said first citation to said renter.

15. A method of managing citations for a fleet of vehicles, the method comprising:
having a fleet owner responsible for a fleet of vehicles and a citation-issuing authority;
providing a computer;
said owner receiving, from said issuing authority, a plurality of citations, each of said citations referencing a vehicle in said fleet, a time and assessing a fine;
placing said citations in computer readable form;
accessing a database of contracts in computer readable form, said database including a plurality of contracts, each of said contracts indicating a time period during which a renter was responsible for said vehicle; and
if said time of a first citation is wholly within said time period of a first contract:
said computer automatically matching said first citation with said first contract;
said computer automatically generating a document, said document indicating that said renter is responsible for paying said fine; and
providing said document to said renter.

16. The method of claim 15 wherein said document indicates that a renter's account will be charged if said renter does not pay said fine prior to a specified time.

17. The method of claim 16 further comprising the step of:
charging said renter's account if said renter does not pay said fine prior to said specified time.

18. The method of claim 17 wherein said computer automatically indicates on said document that said renter is being billed an additional fee.

19. The method of claim 16 further comprising sending information indicative of said due amount to an accounting system.

20. The method of claim 15 wherein said renter provides payment in response to said document.

21. The method of claim 20 wherein said renter pays said fleet owner, who pays said issuing authority.

22. The method of claim 20 wherein said renter pays said issuing authority directly.

23. The method of claim 22 wherein the renter provides proof of said payment to said fleet owner to eliminate said responsibility.

24. The method of claim 15 wherein said step of placing is performed by said issuing authority.

25. The method of claim 15 wherein said step of placing is performed by said owner.

26. The method of claim 15 wherein if said time is not wholly within said time period of any contract in said plurality of contracts said computer indicates that a match was not found and a human being attempts to match said first citation.

27. The method of claim 26 wherein, if there is no contract in said plurality of contracts which has a time period which overlaps with said time, responsibility for said citation is maintained with said owner.

28. The method of claim 26 wherein, if there are multiple contracts in said plurality of contracts which have a time period which overlaps with said time, responsibility for said citation is maintained with said owner.

29. The method of claim 15 wherein, if there is no contract in said plurality of contracts which has a time period which overlaps with said time, responsibility for said citation is maintained with said owner.

30. The method of claim 15 wherein, if there are multiple contracts in said plurality of contracts which have a time period which overlaps with said time, responsibility for said citation is maintained with said owner.

31. The method of claim 15 wherein said step of placing comprises at least one of scanning of paper documents, manual entry of information from documents; or
use of a direct electronic input.

32. The method of claim 15 wherein said fleet of vehicles are rental cars and said owner is a rental car agency.

33. The method of claim 15 wherein said matching is verified by a human prior to the step of said computer automatically generating said document indicating that said renter is responsible for paying said fine.

34. A computer-readable memory storing computer-executable instructions for citation matching, the memory comprising:
computer-executable instructions for inputting a first citation referencing a vehicle in said fleet and a time of said first citation, said first citation also assessing a fine;
computer-executable instructions for accessing a database of contracts, said database including a first contract indicating a time period during which a renter was responsible for said vehicle;
computer-executable instructions for determining if said time of said first citation is wholly within said time period of said first contract and if so:
automatically matching said first citation with said first contract; and
automatically generating a document, said document indicating at least one of the following situations: that said renter is responsible for said fine or that said liability for said fine is being transferred to said renter.

35. The memory of claim 34 wherein said database of contracts is also stored on said memory.

36. The memory of claim 34 wherein said memory is distributed across a plurality of computers.
